(19) United States
(12) Patent Application Publication
(10) Pub. No.: US 2024/0146085 A1
(43) Pub. Date: May 2, 2024

(54) BATTERY CHARGING METHOD AND SYSTEM

(71) Applicant: Trend Power Technology (changshu) Inc., Jiangsu (CN)

(72) Inventors: Tsung-Nan WU, Hsinchu County (TW); Chih-Hsiang HSU, Hsinchu County (TW); Wei-Cheng CHEN, Hsinchu County (TW)

(21) Appl. No.: 18/498,067

(22) Filed: Oct. 31, 2023

(30) Foreign Application Priority Data
Oct. 31, 2022 (TW) 111141446

(51) Int. Cl. H02J 7/00

(52) U.S. Cl. CPC H02J 7/005; H02J 7/0013; H02J 7/0048; H02J 7/007182

(57) ABSTRACT

The present disclosure provides a battery charging system and method. The battery charging method includes: determining a degree of healthy of a battery module according to an evaluation mechanism; setting a charging standard according to the degree of healthy; by handshaking with a charger, setting a charging voltage for the charger according to the charging standard to charge the battery module; and by the charger, perform a charging operation on the battery module until a fully charged condition is satisfied.

### CROSS-REFERENCE TO RELATED APPLICATION

This application claims priority to Taiwan Application Serial Number 111141446, filed Oct. 31, 2022, which is herein incorporated by reference in its entirety.

### BACKGROUND

### Field of Invention

This disclosure relates to a charging method and system, and in particular to a charging method and system for battery.

### Description of Related Art

To stably provide the reserved energy for emergencies, existing energy storage systems usually charge the battery pack therein to the fully charged voltage for storing. Because mostly charging terminals only provide the fixed charging voltage to the energy storage systems, the battery pack would be at the highest voltage and fully charged for a long time. Moreover, the battery pack is often in the high temperature environment, which further accelerates the deterioration in the battery pack so that the battery pack cannot achieve the expected service life. Therefore, it is necessary to improve this.

### SUMMARY

An aspect of present disclosure relates to a battery charging method. The battery charging method includes: determining a degree of healthy of a battery module according to an evaluation mechanism; setting a charging standard according to the degree of healthy; by handshaking with a charger, setting a charging voltage for the charger according to the charging standard to charge the battery module; and by the charger, perform a charging operation on the battery module until a fully charged condition is satisfied.

Another aspect of present disclosure relates to a battery charging system. The battery charging system includes a charger and a battery module. The battery module includes a battery pack and a battery management system, wherein the battery management system dynamically adjusts a target fully charged voltage according to a degree of aging of the battery pack, and notifies the charger according to the target fully charge voltage to set a charging voltage.

### BRIEF DESCRIPTION OF THE DRAWINGS

FIG. 1 is a block diagram of a battery charging system in accordance with some embodiments of the present disclosure;

FIG. 2 is a flow diagram of a battery charging method in accordance with some embodiments of the present disclosure;

FIG. 3 is a histogram of a relationship between a fully charged voltage and a total usage time of a battery pack in accordance with some embodiments of the present disclosure; and

FIG. 4 is a block diagram of the battery charging system in accordance with some embodiments of the present disclosure.

### DETAILED DESCRIPTION

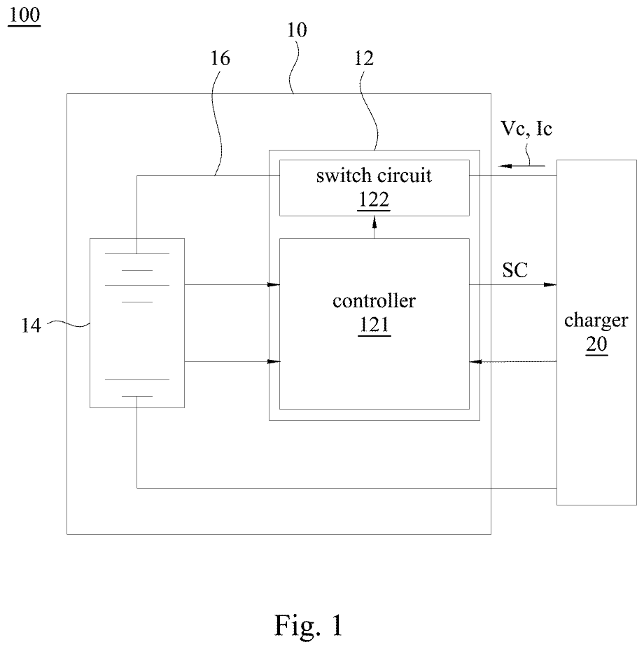

Referring to FIG. 1, FIG. 1 is a block diagram of a battery charging system 100 in accordance with some embodiments of the present disclosure. As shown in FIG. 1, the battery charging system 100 includes a battery module 10 and a charger 20. In some embodiments, the charger 20 is electrically coupled to the battery module 10 and is configured to receive a power signal (not shown) provided by an external power supply (not shown), so as to provide the electric power to charge the battery module 10 when the battery module 10 has insufficient power.

In some embodiments, as shown in FIG. 1, the battery module 10 includes a battery management system 12 and a battery pack 14. In particular, the battery pack 14 includes a plurality of battery cells, the battery cells are connected in series, but the present disclosure is not limited herein. The battery management system 12 is electrically coupled to the battery pack 14 and is configured to control the battery cells of the battery pack 14 to discharge and/or charge. As shown in FIG. 1, the battery management system 12 includes a controller 121 and a switch circuit 122. The switch circuit 122 is electrically coupled between the battery pack 14 and the charger 20 and can be switched to a conductive state or a non-conductive state in the control of the controller 121, so as to conduct or cut off a charging path 16 of the battery module 10.

In the embodiments of FIG. 1, the switch circuit 122 can be implemented by metal oxide semiconductor transistor or other circuit(s) or component(s) having similar function(s), but the present disclosure is not limited herein. The controller 121 can be implemented by central processing unit (CPU), multiprocessor, distributed processing system, processor for applications or other circuit(s) or component(s) having data access, data computation, data storage, data transfer and receive, or similar function(s), but the present disclosure is not limited herein.

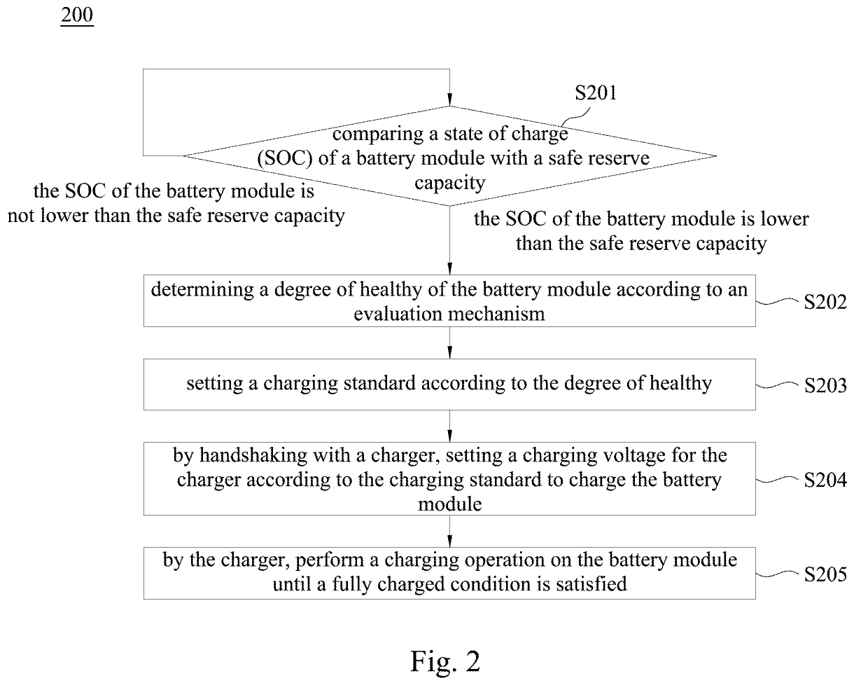

For clarity and convenience of the following descriptions, the operation of the battery charging system 100 would be described in detail with reference to FIG. 2. Referring to FIG. 2, FIG. 2 is a flow diagram of a battery charging method 200 in accordance with some embodiments of the present disclosure. In some embodiments, the battery charging method 200 is suitable for the battery charging system 100. As shown in FIG. 2, the battery charging method 200 can include multiple steps S201-S205.

In step S201, a state of charge (SOC) of the battery module 10 is compared with a safe reserve capacity. In some embodiments, the controller 121 of the battery management system 12 can evaluate the capacity of the battery pack 14 through at least one parameter obtained from the battery pack 14, in which the at least one parameter can include the open circuit voltage, the discharging current or the internal resistance of the battery. The safe reserve capacity can be preset and stored in the battery management system 12 by the user of the battery charging system 100. For example, the safe reserve capacity can be 80-90% of the rated capacity of the battery module 10. In some embodiments, the capacity of the battery pack 14 is referred as the SOC of the battery module.

In some embodiments, as shown in FIG. 2, the controller 121 determines that the SOC of the battery module 10 is lower than the safe reserve capacity, so that step S202 is performed. In some embodiments, the controller 121 determines that the SOC of the battery module 10 is not lower than the safe reserve capacity, so that step S201 is performed again.

In step S202, a degree of healthy of the battery module 10 is determined according to an evaluation mechanism. In some embodiments, the controller 121 of the battery management system 12 can evaluate a degree of aging of the battery pack 14 by way of table lookup, to determine the degree of healthy of the battery module 10. For example, the user of the battery charging system 100 can pre-store a chart (not shown) presenting a relationship between the degree of aging and the total usage time of the battery pack 14 in the battery management system 12. Accordingly, the controller 121 of the battery management system 12 can obtain the degree of aging corresponding to the total usage time of the battery pack 14 according to said chart. In some embodiments, the degree of aging of the battery pack 14 can reflect the degree of healthy of the battery module 10. For example, the higher the degree of aging of the battery pack 14 is, the lower the degree of healthy of the battery module 10 is. Instead, the lower the degree of aging of the battery pack 14 is, the higher the degree of healthy of the battery module 10 is. It should be understood that the above descriptions of determining the degree of healthy of the battery module 10 are only exemplary, and are not intended to limit the present disclosure.

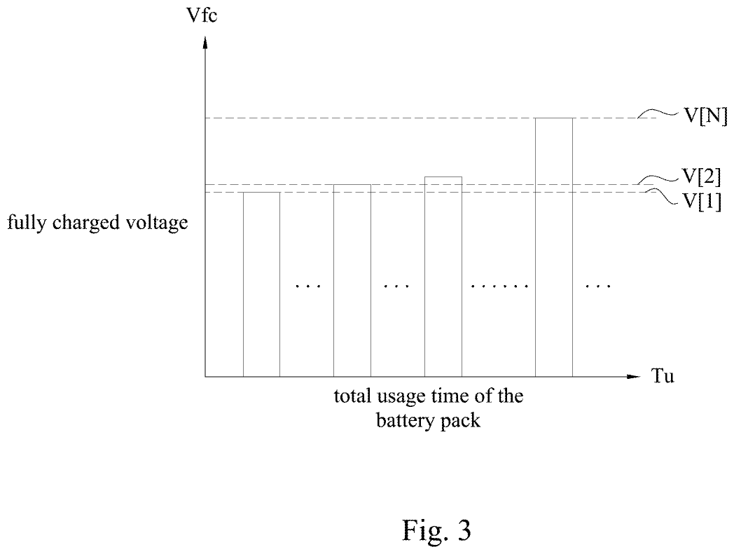

In step S203, a charging standard is set according to the degree of healthy. In some embodiments, the controller 121 of the battery management system 12 sets a fully charged voltage according to the degree of healthy of the battery module 10 (or the degree of aging of the battery pack 14) evaluated in step S202. Referring to FIG. 3, FIG. 3 is a histogram of a relationship between the fully charged voltage Vfc and the total usage time Tu of the battery pack 14 in accordance with some embodiments of the present disclosure. In some embodiments, as shown in FIG. 3, as the total usage time Tu increases, the fully charged voltage Vfc is increased from a voltage value V[1] to a voltage value V[2], and is further increased from the voltage value V[2] to a voltage value V[N], in which the voltage value V[N] is higher than the voltage value V[2], and the voltage value V[2] is higher than the voltage value V[1]. It should be understood that the degree of aging of the battery pack 14 is increased as the total usage time Tu increases. As can be seen from this, the higher the degree of aging of the battery pack 14 is (i.e., the lower the degree of healthy of the battery module 10 is), the higher the fully charged voltage Vfc set by the battery management system 12 is. In other words, the battery management system 12 would dynamically adjust the fully charged voltage Vfc according to the degree of aging of the battery pack 14.

In the above embodiments, the degree of aging of the battery pack 14 (or the degree of healthy of the battery module 10) is presented by the total usage time of the battery pack 14, but the present disclosure is not limited herein. In other embodiments, the degree of aging of the battery pack 14 can be presented by the cycle count, the real maximum capacity or other parameter(s) of the battery pack 14.

In the above embodiments, the charging standard set by the battery management system 12 includes the fully charged voltage Vfc, but the present disclosure is not limited herein. In other embodiments, the charging standard set by the battery management system 12 includes the fully charged voltage Vfc, the fully charged current, the safe reserve capacity, the fully charged capacity or any combination thereof.

In step S204, a charging voltage Vc for the charger 20 to charge the battery module 10 is set according to the charging standard by a handshake with the charger 20. In some embodiments, as shown in FIG. 1, after the charging standard is set, the controller 121 of the battery management system 12 handshakes with the charger 20, and sends a voltage adjustment command SC to the charger 20 according to the charging standard set in step S203, so that the charger 20 sets the charging voltage Vc. As can be seen from this, the battery management system 12 notifies the charger 20 according to the charging standard to set the charging voltage Vc. In some embodiments, the charging voltage Vc is related to the degree of healthy of the battery module 10. For example, the lower the degree of healthy of the battery module 10 is, the higher the charging voltage Vc.

In step S205, a charging operation is performed on the battery module 10 through the charger 20 until a fully charged condition is satisfied. In some embodiments, a period of the charging operation includes a first period and a second period. The charger 20 is operated in a constant current charging mode during the first period, and is then operated in s constant voltage charging mode during the second period. In the constant current charging mode, the charger 20 charges the battery pack 14 to the charging voltage Vc with a constant current Ic (as shown in FIG. 1). After the battery pack 14 is charged to the charging voltage Vc, the charger 20 switches from the constant current charging mode to the constant voltage charging mode. In the constant voltage charging mode, the charger 20 charges the battery pack 14 with the charging voltage Vc, until a voltage value of the battery pack 14 is greater than the fully charged voltage Vfc of the charging standard and a current value of the battery pack 14 is smaller than the fully charged current of the charging standard.

Following the above descriptions, when the voltage value of the battery pack 14 is greater than the fully charged voltage Vfc and the current value of the battery pack 14 is smaller than the fully charged current, the battery pack 14 in the battery module 10 is stopped being charged. To further describe, in some embodiments, the controller 121 of the battery management system 12 switches the switch circuit 122 to the non-conductive state, so as to cut off the charging path 16 of the battery module 10. Accordingly, the charger 20 is unable to provide the charging voltage Vc and/or the constant current Ic to the battery pack 14. However, the present disclosure is not limited to controlling the switch circuit 122 to stop charging the battery pack 14. For example, in other embodiments, the controller 121 of the battery management system 12 handshakes with the charger 20 to notify the charger 20 of not providing the charging voltage Vc and/or the constant current Ic to the battery pack 14.

In some embodiments, after the charge of the battery pack 14 in the battery module 10 is completed, the battery module 10 can be operated in an operation mode to provide the reserve capacity to an electric device (not shown). In addition, after the capacity of the battery pack 14 is lower than the safe reserve capacity again, steps S202-S205 would be performed again.

In the above embodiments, the fully charged condition includes that the voltage value of the battery pack 14 is greater than the fully charged voltage Vfc and that the current value of the battery pack 14 is smaller than the fully charged current, but the present disclosure is not limited herein. In other embodiments, the fully charged condition includes that the capacity of the battery pack 14 is greater than the safe reserve capacity and that the current value of the battery pack 14 is smaller than the fully charged current.

In the above embodiments, the charger 20 is sequentially operated in the constant current charging mode and the constant voltage charging mode to charge the battery pack 14 of the battery module 10, but the present disclosure is not limited herein. In other embodiments, the charger 20 is only operated in the constant current charging mode to charge the battery pack 14 of the battery module 10. In other embodiments, the charger 20 is only operated in the constant voltage charging mode to charge the battery pack 14 of the battery module 10.

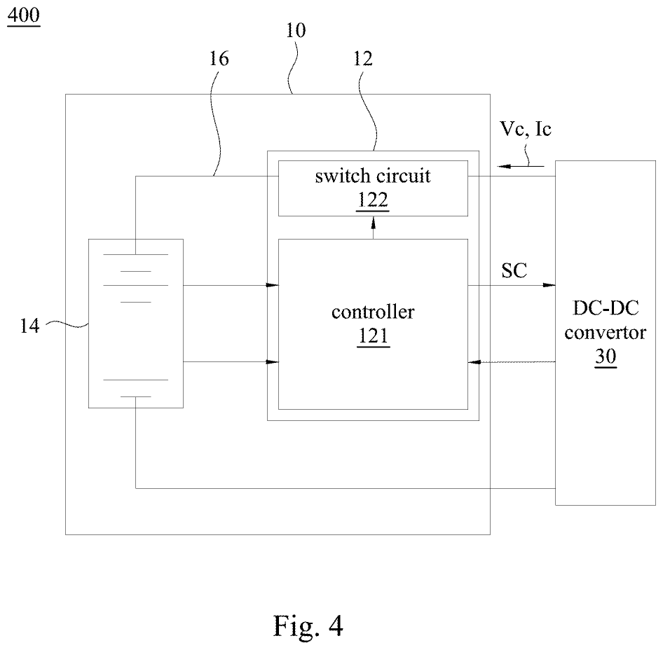

In the above embodiments, the battery module 10 adjusts the charging voltage Vc by handshaking with the charger 20, but the present disclosure is not limited herein. For example, referring to FIG. 4, FIG. 4 is a block diagram of a battery charging system 400 in accordance with some embodiments of the present disclosure. In some embodiments, the battery charging system 400 includes the battery module 10 of FIG. 1 and a DC-DC convertor 30, that is, the charger 20 in the battery charging system 100 is substituted by the DC-DC convertor 30. The battery module 10 can handshake with the DC-DC convertor 30 to adjust the charging voltage Vc generated by the DC-DC convertor 30. Other arrangements and operations of the battery charging system 400 are similar or same as those of embodiments of FIG. 1, and therefore are omitted herein.

In the above embodiments, the fully charged voltage Vfc can be referred as the safe fully charged voltage or the target fully charged voltage.

In sum, the battery charging system and method of the present disclosure sets the appropriated charging standard (e.g., the fully charged voltage) by determining the degree of healthy of the battery module, and adjusts the charging voltage used to charge the battery pack according to the charging standard by handshaking with the charger, so as to keep the healthy battery pack in a low voltage reserve state. By keeping the healthy battery pack in the low voltage reserve state and increasing the fully charged voltage with the aging of the battery pack, the battery charging system and method of the present disclosure can decrease the event that the battery pack cannot achieve the expected service life due to being at the highest voltage and fully charged, so as to extend the life of the battery pack.

Following the above descriptions to further describe, the battery charging system and method of the present disclosure is also suitable for the condition of peak load shaving. In the condition of peak load shaving, the battery pack is usually used frequently, so as to accelerate the deterioration (the aging) in the battery pack. Notably, the battery charging system and method of the present disclosure can keep the healthy battery pack in the low voltage reserve state to avoid above questions.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A battery charging method, comprising:
determining a degree of healthy of a battery module according to an evaluation mechanism;
setting a charging standard according to the degree of healthy;
by handshaking with a charger, setting a charging voltage for the charger according to the charging standard to charge the battery module; and
by the charger, perform a charging operation on the battery module until a fully charged condition is satisfied.

2. The battery charging method of claim 1, further comprising:
comparing a state of charge (SOC) of the battery module with a safe reserve capacity, wherein when the SOC is lower than the safe reserve capacity, the step of determining the degree of healthy is performed.

3. The battery charging method of claim 2, wherein when the SOC is not lower than the safe reserve capacity, the step of comparing the SOC of the battery module with the safe reserve capacity is performed again.

4. The battery charging method of claim 1, wherein the lower the degree of healthy is, the higher the charging voltage is.

5. The battery charging method of claim 1, wherein the fully charged condition comprises:
a current value of the battery module is smaller than a fully charged current of the charging standard; and
a voltage value of the battery module is greater than a safe fully charged voltage of the charging standard.

6. The battery charging method of claim 1, wherein the fully charged condition comprises:
a current value of the battery module is smaller than a fully charged current of the charging standard; and
a state of charge (SOC) of the battery module is greater than a safe reserve capacity of the charging standard.

7. The battery charging method of claim 1, wherein the charging operation comprises:
a constant current charging mode, wherein the battery module is charged to the charging voltage with a constant current in the constant current charging mode; and
a constant voltage charging mode, wherein the battery module is charged with the charging voltage in the constant voltage charging mode until the fully charged condition is satisfied.

8. The battery charging method of claim 1, wherein determining the degree of healthy of the battery module comprises:
evaluating a degree of aging of a battery pack of the battery module, wherein the higher the degree of aging of the battery pack is, the lower the degree of healthy of the battery module.

9. The battery charging method of claim 1, wherein setting the charging standard according to the degree of healthy comprises:
setting a fully charged voltage according to the degree of healthy, wherein the lower the degree of healthy is, the higher the fully charged voltage is.

10. A battery charging system, comprising:
a charger; and
a battery module comprising a battery pack and a battery management system, wherein the battery management system dynamically adjusts a target fully charged voltage according to a degree of aging of the battery pack, and notifies the charger according to the target fully charge voltage to set a charging voltage.

11. The battery charging system of claim 10, wherein the battery management system determines the degree of aging when a state of charge (SOC) of the battery pack is lower than a safe reserve capacity.

12. The battery charging system of claim 10, wherein the higher the degree of aging is, the higher the target fully charged voltage is.

13. The battery charging system of claim 10, wherein the charger charges the battery pack to the charging voltage with a constant current, and then charges the battery pack with the charging voltage until a voltage value of the battery pack is greater than the target fully charged voltage and a current value of the battery pack is smaller than a fully charged current.

14. The battery charging system of claim 10, wherein when a voltage value of the battery pack is greater than the target fully charged voltage and a current value of the battery pack is smaller than a fully charged current, the battery management system notifies the charger by handshaking with the charger to stop charging the battery pack.

15. The battery charging system of claim 10, wherein the battery management system comprises a switch circuit,
wherein when a voltage value of the battery pack is greater than the target fully charged voltage and a current value of the battery pack is smaller than a fully charged current, the battery management system switches the switch circuit to a non-conductive state to stop the charger charging the battery pack.
